(19) United States
(12) Patent Application Publication
(10) Pub. No.: US 2012/0006480 A1
(43) Pub. Date: Jan. 12, 2012

(54) METHOD FOR MANUFACTURING DECORATED MOLDING

(75) Inventors: Satoshi Ohya, Sakura-shi (JP); Yoshinari Santo, Sakura-shi (JP); Toshiro Ariga, Sakura-shi (JP)

(73) Assignee: DIC Corporation, Tokyo (JP)

(21) Appl. No.: 13/121,240

(22) PCT Filed: Mar. 9, 2010
(86) PCT No.: PCT/JP2010/053862

§ 371 Date: May 26, 2011

(30) Foreign Application Priority Data
Mar. 31, 2009 (JP) 2009-085490

(51) Int. Cl. B29C 51/10

(52) U.S. Cl. 156/285

(57) ABSTRACT

There is provided a method for manufacturing a decorated molding having projections and depressions in a decorated surface, the method including, while a heat-shrinkable resin sheet is supported, a step (1) of creating a difference in thickness between an area A and an area B adjacent to each other in the same plane of the resin sheet through irradiation with infrared rays so that the area A and the area B have surface temperatures different from each other and the surface temperature of at least the area A is a surface temperature that is higher than or equal to a temperature T of an inflection point of orientation returning strength of the resin sheet and a step (2) of attaching the resin sheet to an adherend by vacuum forming to achieve integration. In a method for simultaneously performing vacuum forming and decoration, a decorated molding having projections and depressions in a decorated surface can be obtained with high reproducibility without requiring a physical method such as embossing.

### TECHNICAL FIELD

The present invention relates to a method for manufacturing a decorated molding by a method for simultaneously performing vacuum forming and decoration. More specifically, the present invention relates to a method for manufacturing a decorated molding obtained by attaching a resin sheet that can be thermoformed to an adherend using vacuum forming to achieve integration.

### BACKGROUND ART

Conventionally, a resin molding such as an injection molding has been decorated by a method in which a coloring agent such as a pigment is kneaded into a resin to color the resin itself and then injection molding is performed or by a method in which a surface layer of an injection molding is coated with a clear paint or a colored paint by spraying. However, such a method has tended to be not preferable in terms of the protection of the work environment and the external environment against emission of chemical substances in recent years. Thus, means to replace the coating method has been demanded.

There has been proposed a method for simultaneously performing vacuum forming and decoration, that is, a method in which an adhesive layer is formed on a surface of a base sheet mainly composed of an acrylic resin, a polystyrene resin, or an ABS resin, the surface being opposite a surface of the base sheet on which a surface protective layer composed of a crosslinking-curable acrylic resin has been formed, and then a three-dimensional shape is formed by thermoforming while at the same time the attachment to a resin molding is performed to achieve integration (e.g., refer to PTL 1). In this method, decoration of a print-like design can be performed on a resin molding such as an injection molding without using a solvent.

In the above-described method, there have been proposed many designs that provide special beauty and texture by forming projections and depressions in a decorated surface. Examples of the known method include a method in which after projections and depressions are physically formed in a surface of a sheet in advance through pressure contact of a shaped sheet or a heated engraved roll for an embossing or schreinerizing process, a three-dimensional shape is formed by thermoforming while at the same time the attachment to a resin molding is performed to achieve integration and a method in which after a projection/depression pattern layer is formed on a sheet by photolithography using an ionizing radiation-curable resin or the like, thermoforming is performed. However, all of the methods are methods that form projections and depressions on a sheet in advance before thermoforming. In some cases, projections and depressions are reduced because of softening caused by heating during thermoforming, and desired projections and depressions are not formed in a decorated surface when using a resin molding that is an adherend having a deep-drawn shape which requires a high spreading factor. Furthermore, since an embossing machine and a special printing step are required in a sheet-manufacturing step, there is a problem of high cost.

In the past, there was considered a method in which desired projections and depressions are formed after heating without forming projections and depressions on a sheet by a physical method such as embossing. Examples of the method include a method in which by irradiating, with infrared rays, a composite body obtained by providing a certain thermosensitive pattern to a polymer compound that is formed on a base and can be melted at a low temperature, the portion of the thermosensitive pattern is depressed or roughened (e.g., refer to PTL 2); and a method for manufacturing a decorative material, the method including forming a laminated body by laminating a heat-shrinkable resin sheet, a base, and an image layer containing at least a heat-absorbing coloring agent, forming a composite body by laminating another substrate on the base side of the laminated body, and irradiating the laminated body with heat rays from the laminated body side to form depressions or openings in a region corresponding to a heat-absorbing image region of the heat-shrinkable resin sheet (e.g., refer to PTLs 3 and 4). A heat-generating substance such as an infrared absorbing agent absorbs near-infrared light and infrared light to generate heat. With such a phenomenon, in PTLs 2 to 4, depressions or openings are formed by plasticizing a polymer compound that is in contact with the heat-generating substance.

However, the methods described in the above literatures had poor reproducibility, and thus it was difficult to obtain projections and depressions that can satisfy a recently desired design with high reproducibility. In the case where the decorative material described in the above literatures was applied to a thermoforming sheet, that is, in the case where an adhesive layer was formed on the bottom face of the decorative material and then a three-dimensional shape was formed by thermoforming while at the same time the attachment to a resin molding was performed to achieve integration, projections and depressions were not formed.

### CITATION LIST

### Patent Literature

PTL 1: Japanese Unexamined Patent Application Publication No. 2000-153587
PTL 2: Japanese Unexamined Patent Application Publication No. 49-31757
PTL 3: Japanese Unexamined Patent Application Publication No. 50-59448
PTL 4: Japanese Unexamined Patent Application Publication No. 50-61455

### SUMMARY OF INVENTION

### Technical Problem

An object of the present invention is to provide a method for obtaining a decorated molding having projections and depressions in a decorated surface with high reproducibility by a method for simultaneously performing vacuum forming and decoration, without employing a physical method such as embossing.

### Solution to Problem

The inventors of the present invention have solved the above-described problem by, in the state in which part or all of only the periphery of a heat-shrinkable resin sheet is secured, that is, a surface of the sheet to be attached to an adherend is not at all supported by a substrate or the like, creating a difference in thickness between an area A and an area B adjacent to each other in the same plane of the resin sheet through irradiation with infrared rays so that the area A and the area B have surface temperatures different from each other and the surface temperature of one of the area A and the area B is a surface temperature that is higher than or equal to a temperature T of an inflection point of orientation returning strength of the resin sheet and by attaching the resin sheet to the adherend by vacuum forming to achieve integration.

Through the application of heat, the heat-shrinkable resin sheet shrinks into its original state before stretching. The force exerted herein is orientation returning strength, which varies depending on heating temperature.

The inventors of the present invention have found that by heating the heat-shrinkable resin sheet while the resin sheet is supported so that a plurality of areas in the same plane of the resin sheet have surface temperatures different from each other and the surface temperature of at least one of the plurality of areas is a surface temperature that is higher than or equal to a temperature T of an inflection point of orientation returning strength of the resin sheet, the difference in thickness can be created between the areas as a result of different sheet behaviors in the plurality of areas. In the present invention, it has been succeeded that the difference in thickness, that is, projections and depressions are intentionally created by using the difference in temperature of the sheet.

To irradiate the resin sheet with infrared rays so that a plurality of areas in the same plane of the resin sheet have surface temperatures different from each other (herein, an area having a relatively high surface temperature is assumed to be the area A and an area having a relatively low surface temperature is assumed to be the area B), there are specific methods ((1) to (3) below) that use an infrared absorption ink or an infrared reflection ink.

The infrared absorption ink is an ink that absorbs infrared rays and the infrared reflection ink is an ink that reflects infrared rays.

The infrared absorption ink is an ink containing an infrared absorbing agent or the like and thus absorbs infrared rays applied and generates heat. That is, when a resin sheet on which printing has been performed with an infrared absorption ink is irradiated with infrared rays, heat in an amount that is more than or equal to the amount to be applied by the irradiation with infrared rays is applied to only an area on which printing has been performed with the infrared absorption ink.

In contrast, the infrared reflection ink is an ink containing an infrared reflecting material and thus reflects infrared rays applied. When a resin sheet on which printing has been performed with the infrared reflection ink is irradiated with infrared rays from the resin sheet side (i.e., a surface opposite the surface of the resin sheet on which printing has been performed), heat in an amount that is more than or equal to the amount to be applied by the irradiation with infrared rays is applied to only a printed area where an infrared-ray-transmitted area and a reflection area overlap each other because the infrared rays that have passed through the resin sheet are reflected by the infrared reflection ink (this may be specifically because heat can be efficiently supplied to the sheet in the area A compared with the area B having no pattern).

In other words, since heat in an amount that is more than or equal to the amount to be applied by the irradiation with infrared rays is applied to only an area where printing has been performed with the infrared absorption ink or the infrared reflection ink, the surface temperature of such an area can be increased. As a result, a difference in temperature can be created between the areas of the resin sheet where printing has been performed with the infrared absorption ink and where no printing has been performed.

Specifically, (1) a heat-shrinkable resin sheet has a pattern formed with an infrared absorption ink or an infrared reflection ink and is irradiated with infrared rays so that an area A having the pattern formed with the infrared absorption ink or the infrared reflection ink and an area B having no pattern have surface temperatures different from each other. Since heat in an amount that is more than or equal to the amount to be applied by the irradiation with infrared rays is applied to only the area A, the surface temperature of the area A becomes higher than that of the area B where no printing has been performed.

Alternatively, (2) a heat-shrinkable resin sheet has a pattern formed with an infrared absorption ink or an infrared reflection ink so as to include an area A having a high ink concentration and an area B having a low ink concentration and is irradiation with infrared rays so that the area A having a high ink concentration and the area B having a low ink concentration have surface temperatures different from each other.

In this case, although heat in an amount that is more than or equal to the amount to be applied by the irradiation with infrared rays is applied to both the area A and the area B, a larger amount of heat is applied to the area A than the area B because the area A has an ink concentration higher than the area B. Thus, the surface temperature of the area A becomes relatively higher than that of the area B.

Alternatively, (3) a heat-shrinkable resin sheet has a pattern formed with multiple types of infrared absorption inks having different infrared absorptances or multiple types of infrared reflection inks having different infrared reflectances and includes an area A having a pattern formed with an ink having a high infrared absorptance or reflectance and an area B having a pattern formed with an ink having a low infrared absorptance or reflectance so that the area A and the area B have surface temperatures different from each other.

In this case, although heat in an amount that is more than or equal to the amount to be applied by the irradiation with infrared rays is applied to both the area A and the area B, a larger amount of heat is applied to the area A than the area B because the area A is formed with an ink having an infrared absorptance or reflectance higher than that of the area B. Thus, the surface temperature of the area A becomes relatively higher than that of the area B.

In the sheet on which the difference in thickness has been created, projections and depressions are uniformly formed on both sides of the sheet. Thus, by attaching the sheet to an adherend using vacuum forming in the subsequent step, clear projections and depressions can be formed with high reproducibility even on an adherend having a deep-drawn shape which requires a high spreading factor.

In other words, the present invention provides a method for manufacturing a decorated molding having projections and depressions in a decorated surface, the method including, while a heat-shrinkable resin sheet is supported, a step (1) of creating a difference in thickness between an area A and an area B adjacent to each other in the same plane of the resin sheet through irradiation with infrared rays so that the area A and the area B have surface temperatures different from each other and the surface temperature of at least the area A is a surface temperature that is higher than or equal to a temperature T of an inflection point of orientation returning strength of the resin sheet; and a step (2) of attaching the resin sheet to an adherend by vacuum forming to achieve integration.

### Advantageous Effects of Invention

According to the present invention, there can be provided a decorated molding having projections and depressions in a decorated surface with high reproducibility by a method for simultaneously performing vacuum forming and decoration, without employing a physical method such as embossing.

In the present invention, when the above-described means (1) to (3) are employed so that the plurality of areas that are present in the same plane of the resin sheet have surface temperatures different from each other, projections and depressions are formed in the area having a pattern formed with the infrared absorption ink or the infrared reflection ink. The pattern can be printed with the ink by a typical printing method such as gravure printing, which does not require a physical method for forming projections and depressions. Therefore, excessive machines are not required in the sheet-manufacturing step, thereby reducing the cost.

Since projections and depressions are uniformly formed on both sides of the sheet by irradiating the sheet with infrared rays while the sheet is supported and furthermore the sheet is attached to the adherend by vacuum forming while the difference in thickness is created in the sheet, clear projections and depressions can be formed with high reproducibility even on an adherend having a deep-drawn shape which requires a high spreading factor.

Moreover, by irradiating the sheet with infrared rays while the sheet is supported under vacuum that has no heat conduction, the difference in temperature can be more distinctly created on the sheet, which can provide clearer projections and depressions.

### DESCRIPTION OF EMBODIMENTS

### Definition of Projections and Depressions

In the present invention, as described above, projections and depressions are formed by causing the surface temperatures of an area A and an area B adjacent to each other in the same plane of a heat-shrinkable resin sheet to be different from each other while the resin sheet is supported. In the present invention, an area having a relatively high surface temperature is defined as the area A and an area having a relatively low surface temperature is defined as the area B. Herein, relatively, the area A becomes a depression and the area B becomes a projection.

It is believed that, in the area A, when a resin is plasticized by irradiating the heat-shrinkable resin sheet with infrared rays and the orientation returning of the resin sheet starts to occur, the thickness of the center of the resin sheet is decreased due to its autogenous shrinkage behavior.

In this change in thickness due to the autogenous shrinkage behavior, if the resin sheet is not supported, shrinkage occurs overall without a starting point and the thickness tends to become larger on the whole. However, in the state in which only part or all of the periphery of the resin sheet is supported using a clamp or the like (hereinafter may be simply referred to as “supported state”), shrinkage tends to occur from a clamped portion that has low temperature and serves as a starting point. As a result, it is believed that the thickness of the area A is decreased.

Thus, the thickness of the area A is often decreased compared with the thickness of the resin sheet before the irradiation with infrared rays, that is, before the shrinkage.

In contrast, the area B is an area that is adjacent to the area A and has a surface temperature different from that of the area A, the surface temperature being relatively lower than that of the area A. It is believed that the area B is formed through the movement of a resin component in the area A, the movement being caused by decreasing the thickness of the center of the area A, or through autogenous shrinkage. As a result, the thickness of the area B becomes relatively larger than that of the area A. In most cases, the thickness of the area B is increased compared with the thickness of the resin sheet before the irradiation with infrared rays, that is, before the shrinkage. It is also observed that the thickness in the boundary between the area A and the area B is further increased (refer to FIG. 3). This can provide more outstanding impression of projections and depressions.

FIGS. 1 to 3 show an example in which the projections and depressions are formed. FIG. 1 is a diagram showing a specific embodiment that illustrates the state in which a heat-shrinkable resin sheet having a pattern printed thereon using three types of inks, namely a high-concentration infrared absorption ink, a low-concentration infrared absorption ink, and a color ink (having no infrared absorption) is irradiated with infrared rays using an infrared heater. FIG. 2 is a diagram showing the state of the resin sheet obtained after the resin sheet is irradiated with infrared rays while the resin sheet is supported in FIG. 1. FIG. 3 is a diagram showing the state in which the resin sheet of FIG. 2 is attached to an adherend by vacuum forming to achieve integration.

By irradiating the resin sheet with infrared rays as shown in FIG. 1, the thickness of a printed area 4 with the high-concentration infrared absorption ink, that is, the thickness of the area A is decreased most, which means the area A becomes a depression. The thickness of the low-concentration infrared absorption ink 5 is larger than that of the printed area 4, but is smaller than that of a printed area 6 with the color ink. Therefore, the low-concentration infrared absorption ink 5 is regarded as a projection with respect to the printed area 4, and the printed area 6 with the color ink is the thickest and thus is the largest projection.

In the case of a resin sheet having a non-printed area without using the printed area 6 with the color ink, the printed area with a high-concentration infrared absorption ink becomes a depression, the printed area with a low-concentration infrared absorption ink becomes a low projection, and the non-printed area becomes the highest projection (not shown).

Since relatively thin portions and relatively thick portions are created as described above, projections and depressions are formed.

The projections and depressions are uniformly formed on both sides of the resin sheet as shown in FIG. 2. Thus, the surface of the resin sheet that contacts an adherend also has projections and depressions. However, when the resin sheet is attached to the adherend by vacuum forming in this state, a decorated molding having projections and depressions that neatly adhere to the adherend can be obtained without causing lifting or the like on the decorated surface of the adherend (refer to FIG. 3). It is also confirmed that the difference in elevation between the sheet surfaces of the area A and the area B is larger than that in the state shown in FIG. 2, that is, before the vacuum forming. This may be because, since the resin sheet is molded while being plasticized (i.e., while being heated) in vacuum forming, the area A having a small thickness also contacts the adherend under pressure while being plasticized, whereby the area A also closely adheres to the surface of the adherend and the difference in elevation between the sheet surfaces of the area A and the area B that has a relatively large thickness is further increased.

The difference in elevation between the projections and depressions can be measured with a surface roughness meter or a film thickness meter. When the difference (hereinafter referred to as difference in thickness) between the highest area and the lowest area of the decorated surface having projections and depressions is about 10 μm, the difference can be recognized as the formation of projections and depressions. To form distinct projections and depressions, the difference in thickness is preferably about 15 μm and more preferably 20 μm or more. Since the difference in thickness is decreased in proportion to the spreading factor, the difference in thickness between projections and depressions tends to be decreased as a molding has a larger depth. Furthermore, the width of each of the projections and depressions tends to be increased as the spreading factor is increased.

The design expressed by projections and depressions in the present invention is not particularly limited, and the thickness, size, shape, and the like of a drawing that express patterns, characters, and the like are also not particularly limited. That is, the present invention can provide any projection and depression as long as patterns and characters can be formed on a plate or printed by printing, handwriting, or the like using the above-described means (1) to (3).

Examples of the design include drawings expressed by stippling or line drawing (specifically, the outline, grain, stripe, hairline, and the like of paintings and characters), dots, and geometric patterns. To emboss the characters or marks themselves, the area of the pattern is preferably small. Obviously, the present invention is not limited thereto, and any design including patterns and characters can be expressed.

FIGS. 4 to 7 show examples of the patterns expressed by projections and depressions in the present invention. Black portions are portions that are printed in a patterned manner with an infrared absorption ink or an infrared reflection ink. FIG. 4 shows stripes, FIG. 5 shows dots, FIG. 6 shows geometric patterns, and FIG. 7 shows grain.

### (Surface Temperature)

In the present invention, although “surface temperature of the area A and the area B” is defined as an indicator of the temperature, it is believed that the thermal behavior in the area A and the area B of the resin sheet is caused in the state in which heat is not only uniformly applied to the surfaces of the area A and the area B, but also uniformly conducted to the inside thereof. However, since there is no means for measuring internal temperature, the temperature is defined as surface temperature. In the present invention, the surface temperature is measured with “Thermo Tracer 9100” manufactured by NEC Avio Infrared Technologies Co., Ltd.

### (Heat-Shrinkable Resin Sheet)

The heat-shrinkable resin sheet used in the present invention (hereinafter abbreviated as resin sheet S) is composed of a resin that shows extensibility by heating and can be formed into a film. Furthermore, the heat-shrinkable resin sheet is a resin sheet having an inflection point of orientation returning strength, and is preferably a thermoplastic resin sheet in order to achieve ease of extension during vacuum forming.

A temperature of an inflection point of orientation returning strength in the present invention is a film temperature obtained when heat is applied to a film from the outside, the film temperature being a temperature at which the stretched molecules start to shrink, whereby the entire film is shrunk. In the present invention, a temperature T of an inflection point of orientation returning strength is defined as follows.

The orientation returning strength used in the present invention is measured in accordance with ASTM D-1504. Orientation returning strength is a force exerted, when the stretched sheet is heated, that attempts to return the sheet to its state before stretching. The strength is a value obtained by dividing the maximum stress at each measurement temperature by the cross-sectional area of the sheet, which indicates the degree of molecular orientation of the stretched sheet. In the present invention, the temperature T of an inflection point that is a convex point of an upward-sloping graph which shows the relationship between orientation returning strength and heating temperature is obtained using the above-described heat shrinkage stress measurement method. In the case where there are a plurality of inflection points that are convex, the temperature of an inflection point in the highest temperature range is employed as the temperature T of an inflection point of orientation returning strength.

Specifically, orientation returning stress at each temperature was measured using a D. N-type stress tester manufactured by Nichiri Kogyo co. by increasing the temperature of a heater in 5° C. increments at a voltage regulating scale of 6. After the shrinkage stress was generated, the temperature T at an inflection point of a graph that shows the relationship between orientation returning strength and heating temperature was measured. FIG. 16 shows the example. FIG. 16 is a graph obtained by measuring a biaxially stretched PET sheet “Soft Shine X1130 (thickness: 125 μm)” (sheet S1 in Examples) manufactured by TOYOBO Co., Ltd. The temperature T of an inflection point that is convex in the highest temperature range in the graph, which was 188° C., was employed as the temperature T of an inflection point of orientation returning strength of the sheet S1.

As described above, the resin sheet having an inflection point of orientation returning strength is normally subjected to stretching treatment. The stretching treatment is normally performed by melt-extruding a resin into a sheet by an extrusion film formation method and then performing simultaneous biaxial stretching or sequential biaxial stretching. In the case of sequential biaxial stretching, normally, vertical stretching is first performed and then transverse stretching is performed. Specifically, there is often employed a method that combines vertical stretching that utilizes the difference in speed between rolls and transverse stretching that utilizes a tenter.

A tenter method has advantages of providing broad products and high productivity. The stretch conditions are not particularly limited because they vary in accordance with resin plasticity and intended physical properties and moldability. The stretch ratio is normally 1.2 to 18 times and more preferably 2.0 to 15 times in terms of surface ratio. In the case of sequential stretching, the stretch ratio in a machine direction is 1.2 to 5 times and preferably 1.5 to 4.0 times, and the stretch ratio in a direction perpendicular to the machine direction is 1.1 to 5 times and preferably 1.5 to 4.5 times. In the case of simultaneous biaxial stretching, the stretch ratio in each direction is 1.1 to 3.5 times and preferably 1.2 to 4.2 times.

Specifically, a stretched sheet such as a uniaxially stretched sheet or a biaxially stretched sheet can be used, and a biaxially stretched sheet is preferred because the advantage of the present invention can be maximized. Furthermore, since a simultaneous biaxially stretched sheet has a uniform in-plane shrinkage, uneven design without distortion can be obtained. However, a uniaxially stretched sheet or a two-stage sequential biaxially stretched sheet is sometimes used by calculating distortion in advance.

The resin used is not particularly limited as long as the resin is stretchable. Examples of the resin include polyester resins such as polyethylene terephthalate and polybutylene terephthalate, polyolefin resins such as polyethylene and polypropylene, polyvinyl chloride, acrylic resins, polystyrene resins, nylon, and vinylon. Among these resins, a polyester resin is preferably employed because it has a uniform thickness after stretching.

The thickness of the resin sheet S is not particularly limited as long as the thickness is a typical thickness of a sheet for thermoforming that is used in vacuum forming. Generally, the thickness of a sheet is preferably about 0.1 to 0.5 mm.

As described above, by the methods (1) to (3) that utilize the infrared absorption ink or the infrared reflection ink, the resin sheet is irradiated with infrared rays so that a plurality of areas in the same plane have surface temperatures different from each other.

### (Infrared Absorption Ink or Infrared Reflection Ink)

The infrared absorption ink or the infrared reflection ink used in the means (1) to (3) will be described.

An infrared absorption ink is an ink containing an infrared absorbing agent. An infrared reflection ink is an ink containing an infrared reflecting material. Both of them are inks used for a security ink or the like.

As described above, the infrared absorption ink absorbs infrared rays applied and generates heat. That is, when a resin sheet on which printing has been performed with the infrared absorption ink is irradiated with infrared rays, heat in an amount that is more than or equal to the amount to be applied by the irradiation with infrared rays is applied to only an area on which printing has been performed with the infrared absorption ink. In contrast, the infrared reflection ink is an ink containing an infrared reflecting material and thus reflects infrared rays applied. When a resin sheet on which printing has been performed with the infrared reflection ink is irradiated with infrared rays from the resin sheet side (i.e., a surface opposite the surface of the resin sheet on which printing has been performed), heat in an amount that is more than or equal to the amount to be applied by the irradiation with infrared rays is applied to only a printed area where an infrared-ray-transmitted area and a reflection area overlap each other because the infrared rays that have passed through the resin sheet are reflected by the infrared reflection ink. In other words, since heat in an amount that is more than or equal to the amount to be applied by the irradiation with infrared rays is applied to only an area where printing has been performed with the infrared absorption ink or the infrared reflection ink, the surface temperature of such an area can be increased. As a result, a difference in temperature can be created between the areas of the resin sheet where printing has been performed with the infrared absorption ink and where no printing has been performed.

Vacuum forming is a method in which a resin sheet to be processed by vacuum forming is irradiated with infrared rays so as to be brought into an elastic region that is suitable for thermoforming. Similarly, in the present invention, the temperature of the resin sheet S itself is increased by irradiation with infrared rays so that the resin sheet S is brought into an elastic region that is suitable for thermoforming. Herein, if there is an area on the resin sheet S to which the infrared absorption ink or the infrared reflection ink has been applied, heat is further applied and thus projections and depressions are formed. The area A (the area having a relatively high surface temperature) in this state may have a surface temperature that is higher than or equal to the temperature T of an inflection point of orientation returning strength of the resin sheet S. Furthermore, the difference in temperature between the area A and the area B is preferably 7° C. or higher, more preferably 10° C. or higher to provide larger projections and depressions, and further preferably 15° C. or higher.

Irradiation with infrared rays may be performed so that only the area A has a surface temperature that is higher than or equal to the temperature T of an inflection point of orientation returning strength. Alternatively, irradiation with infrared rays may be performed so that both the area A and the area B have a surface temperature that is higher than or equal to the temperature T of an inflection point of orientation returning strength. In this case, the latter can provide larger projections and depressions.

The infrared absorption ink is preferably an ink containing a material that is commercially available as an infrared absorbing agent or various known infrared absorbing pigments or dyes that generate heat by absorbing laser beams having a wavelength in red, near-infrared, and infrared regions. Examples of the infrared absorbing agent include insoluble azo pigments, azo lake pigments, condensed azo pigments, chelate azo pigments, phthalocyanine-based pigments, anthraquinone-based pigments, perylene/perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, carbon black, azo dyes, metal complex azo dyes, pyrazolone azo dyes, anthraquinone dyes, phthalocyanine dyes, carbonium dyes, quinonimine dyes, methine dyes, cyanine dyes; pigments and dyes of carbon black, titanium black, titanium oxide, Cu—Cr-based composite oxides, phthalocyanine, naphthalocyanine, and cyanine; polymethine-based pigments and dyes; and red absorbing agents, near-infrared absorbing agents, and infrared absorbing agents such as squarylium dyes.

Examples of the infrared reflecting material contained in the infrared reflection ink include metals such as aluminum, gold, silver, copper, brass, titanium, chromium, nickel, nickel chromium steel, and stainless steel, Fe—Cr-based composite oxides, antimony trioxide, and antimony dichromate. The infrared reflecting material is preferably used in the form of powder or small pieces.

The particle size of the infrared absorbing agent or the infrared reflecting material is not particularly limited as long as the particle size is within the range of the particle size of typically used inks.

The amount of heat applied to the area A is increased as the concentration of the ink is increased. Thus, preferably, the content of the ink is suitably changed in accordance with the degree of desired projections and depressions. If the concentration is excessively low, the amount of heat generated by irradiation with infrared rays or the amount of infrared rays reflected is excessively decreased, whereby depressions are not formed. If the concentration is excessively high, the amount of heat generated by irradiation with infrared rays or the amount of infrared rays reflected is excessively increased, thereby causing tears, hole opening, or the like. Therefore, the concentration needs to be suitably adjusted so that the elastic modulus during molding does not fall below 0.5 MPa as described below.

An ink varnish is also not particularly limited, and a publicly known resin for varnish can be used. Examples of the resin for varnish include acrylic resins, polyurethane resins, polyester resins, vinyl resins (vinyl chloride, vinyl acetate, and vinyl chloride-vinyl acetate copolymer resin), chlorinated olefin resins, ethylene-acrylic resins, petroleum-based resins, and cellulosic resins.

In accordance with a desired design, a general-purpose coloring material or the like may be added to the infrared absorption ink or the infrared reflection ink. Herein, by using an infrared absorbing agent or an infrared reflecting material having high transparency, such a general-purpose coloring material can be used effectively, which is preferable. Another pattern layer may be separately formed with an ink containing a general-purpose coloring material using a different plate. The coloring material used in this case is not particularly limited. However, since a coloring material having a heat absorbing property can form projections and depressions in the printed area, the ratio of the coloring material added is preferably changed depending on the purpose.

In the above means (1) to (3), a method for forming a pattern on the resin sheet S using the infrared absorption ink or the infrared reflection ink is handwriting, coating, printing, or the like. From an industrial viewpoint, printing is preferred. The method is not particularly limited, and examples of the method include gravure printing, offset printing, screen printing, inkjet printing, brush coating, roll coating, comma coating, rod gravure coating, and micro gravure coating. Among these methods, gravure printing is preferred.

Normally, the pattern is preferably formed between the resin sheet S and the adherend when the resin sheet is attached to the adherend because the pattern is protected by the resin sheet S and the beauty is provided. As shown in FIG. 1, the irradiation with infrared rays is normally performed so that the infrared rays pass through the resin sheet and reaches the infrared absorption ink or the infrared reflection ink. In particular when the infrared reflection ink is used, this irradiation method is required. Otherwise, the infrared reflection ink reflects infrared rays before the infrared rays pass through the resin sheet. That is, it is possible that the infrared rays do not reach the printed area of the resin sheet and thus plasticization does not occur. For example, in the case where an infrared radiation device in a vacuum forming machine used is disposed between the supporting unit (clamp) for a sheet to be molded and the adherend, that is, in the case where a vacuum forming machine designed to apply heat to a sheet to be molded from the contact surface between the sheet and the adherend is used, the decorated portion of the resultant decorated molding is preferably formed in the order of ink layer containing a material that reflects heat obtained from infrared rays/resin sheet S/adherend.

In the means (1), the area A on which a pattern has been formed with the infrared absorption ink or the infrared reflection ink has a relatively higher surface temperature because heat is applied in an amount that is more than or equal to the amount obtained by irradiation with infrared rays. Consequently, the area A becomes a depression. On the other hand, the area B on which no pattern is formed has a relatively lower surface temperature than the area A because heat is applied only in an amount that is equal to the amount obtained by irradiation with infrared rays. Consequently, the area B becomes a projection.

In the means (2), heat in an amount that is more than or equal to the amount obtained by irradiation with infrared rays is applied to both the area A and the area B. However, since the area A has an ink concentration higher than that of the area B, a larger amount of heat is applied to the area A than the area B. Thus, the area A has a relatively higher surface temperature than the area B. Consequently, the area A becomes a depression and the area B becomes a projection.

In the means (2), specifically, the ink concentration can be adjusted by forming the area A and the area B using inks having different ink concentrations or by using only one type of ink and applying a larger amount of the ink to the area A than the area B.

The area A is not necessarily only one. For example, when three types of inks having different ink concentrations are used, an area formed using an ink having the lowest concentration becomes the area B, which is a projection, and an area formed using an ink having the highest concentration becomes the area A, which is a depression having the largest depth. Obviously, this can be adjusted by the amount of ink applied.

In the means (3), heat in an amount that is more than or equal to the amount obtained by irradiation with infrared rays is applied to both the area A and the area B. However, since the area A is formed using an ink with infrared absorptance or reflectance higher than that of the area B, a larger amount of heat is applied to the area A than the area B. Thus, the area A has a relatively higher surface temperature than the area B. Consequently, the area A becomes a depression and the area B becomes a projection.

The absorptance of the infrared absorption ink and the reflectance of the infrared reflection ink cannot be generally compared with each other. As a rough idea, in the case where an infrared reflection ink containing aluminum and an infrared absorption ink containing carbon black are used together, an area formed using the ink containing aluminum becomes a depression and an area formed using the ink containing carbon black becomes a projection. In the case where an infrared absorption ink containing carbon black and an infrared absorption ink containing titanium oxide are used together, an area formed using the ink containing carbon black becomes a depression and an area formed using the ink containing titanium oxide becomes a projection.

Specifically, when printing is performed on the area A using the ink containing aluminum and on the area B using the ink containing carbon black, the area A becomes a depression and the area B becomes a projection. Furthermore, when printing is performed on the area A using the ink containing carbon black and on the area B using the ink containing titanium oxide, the area A becomes a depression and the area B becomes a projection. Thus, a heat-generating substance can be suitably selected in consideration of a desired uneven design and a pattern design having viewability.

The means (1) to (3) can be employed in a mixed manner. For example, in the case where printing is performed on the resin sheet S using the infrared absorption ink so that there are areas formed by single-plate printing and multi-plate printing and a non-printed area is also formed, the following projections and depressions can be provided. The area formed by multi-plate printing becomes a depression having the largest depth, the area formed by single-plate printing becomes a projection compared with the area formed by multi-plate printing and becomes a depression compared with the non-printed area, and the non-printed area becomes a projection.

In the case where printing is performed using infrared absorption inks having a low concentration and a high concentration and a non-printed area is also formed, the following projections and depressions can be provided. The area formed using the ink having a high concentration becomes a depression having the largest depth, the area formed using the ink having a low concentration becomes a projection compared with the area formed using the ink having a high concentration and becomes a depression compared with the non-printed area, and the non-printed area becomes a projection.

### (Other Optional Layers and Adhesive Layer)

In addition to the resin sheet S, other layers may be formed as long as the advantages of the present invention are not lost. In the present invention, since a sheet that has an inflection point of orientation returning strength and exhibits heat shrinkability through application of heat is used, a resin layer that does not inhibit the shrinkability and exhibits plasticity at a temperature lower than that of the resin sheet S can be added. Even a resin layer that exhibits plasticity at a temperature higher than that of the resin sheet S can be added as long as the resin layer has flexibility to the extent that the resin layer can follow the difference in thickness between the area A and the area B. From this point of view, the addition of an adhesive agent composed of a resin layer that exhibits plasticity or an adhesive layer such as a gluing agent is preferable to increase the adhesive strength between the adherend and the resin sheet S. A material of the adhesive layer that adheres to the resin sheet S and the adherend can be suitably selected.

The adhesive layer is preferably formed on a surface of the resin sheet S that is to be brought into contact with the adherend. In many cases, the resin sheet S is provided in order to also protect a decorated surface. Therefore, when an ink containing a heat-generating substance is used, the layered structure is preferably formed in the order of resin sheet S/ink containing heat-generating substance/adhesive layer.

Examples of the adhesive agent include acrylic resin, urethane resin, urethane-modified polyester resin, polyester resin, epoxy resin, ethylene-vinyl acetate copolymer resin (EVA), vinyl chloride resin, vinyl chloride-vinyl acetate copolymer resin, natural rubber, and synthetic rubbers such as SBR, NBR, and silicone rubber. A solvent-type adhesive agent or a solventless-type adhesive agent can be used.

Any gluing agent may be used as long as it has tack at a thermoforming temperature. Examples of the gluing agent include solvent-type gluing agents such as acrylic resin, isobutylene rubber resin, styrene-butadiene rubber resin, isoprene rubber resin, natural rubber resin, and silicone resin; and solventless-type gluing agent such as acrylic emulsion resin, styrene-butadiene latex resin, natural rubber latex resin, styrene-isoprene copolymer resin, styrene-butadiene copolymer resin, styrene-ethylene-butylene copolymer resin, ethylene-vinyl acetate resin, polyvinyl alcohol, polyacrylamide, and polyvinyl methyl ether.

In particular, an acrylic resin or a polyurethane resin (e.g., TYFORCE and CRISVON manufactured by DIC Corporation and NIPPOLAN manufactured by Nippon Polyurethane Industry Co., Ltd.) is preferably exemplified as the adhesive agent. A gluing agent composed of a solvent-type acrylic resin (e.g., QUICKMASTER and FINETACK manufactured by DIC Corporation and SK-Dyne manufactured by Soken Chemical & Engineering Co., Ltd.) is exemplified as the gluing agent in terms of transparency and weather resistance. These may be used in combination.

A tack-imparting agent (tackifier) may be added to the gluing agent to adjust the tack strength. The tackifier is not particularly limited, and examples of the tackifier include rosin resin, rosin ester resin, terpene resin, terpene phenol resin, phenol resin, xylene resin, coumarone resin, coumarone-indene resin, styrene resin, aliphatic petroleum resin, aromatic petroleum resin, aliphatic-aromatic copolymer petroleum resin, alicyclic hydrocarbon resin, and modified products, derivatives, and hydrogenated products of the foregoing.

The amount of the tackifier added is not particularly limited, and is preferably 100 parts by mass or less and more preferably 50 parts by mass or less relative to 100 parts by mass of the total resin solid content.

Even a crosslink-type resin layer that exhibits plasticity at a temperature higher than that of the resin sheet S can be added as long as the resin layer has flexibility to the extent that the resin layer can follow the difference in thickness between the area A and the area B. From this point of view, in order to impart wear resistance, scratch resistance, weather resistance, contamination resistance, water resistance, chemical resistance, thermal resistance, and the like, the resin layer may have a partly-crosslinked surface protective layer to the extent that extensibility is not inhibited. The crosslinking configuration is not particularly limited. There may be employed a conventional reaction such as a heat-curing reaction between isocyanate and a hydroxyl group, a heat-curing reaction between an epoxy group and a hydroxyl group, a ultraviolet-curing or heat-curing reaction that uses a radical polymerization reaction of (meth)acryloyl group, or a hydrolysis condensation reaction of a silanol group or a hydrolyzable silyl group. Herein, a heat-curing reaction between isocyanate and a hydroxyl group is preferably used because a crosslinking reaction can be promoted using the heat generated during thermoforming.

The thickness of the resin sheet S used in the present invention is not particularly limited as long as the total thickness of the resin sheet S including the infrared absorption ink or infrared reflection ink and other layers is a typical thickness of a sheet for thermoforming that is used in vacuum forming.

### (Manufacturing Method)

In the present invention, a method for manufacturing a decorated molding having projections and depressions in a decorated surface specifically includes, while the resin sheet S subjected to the means (1) to (3) is supported, a step (1) of creating a difference in thickness between an area A and an area B adjacent to each other in the same plane of the resin sheet through irradiation with infrared rays so that the area A and the area B have surface temperatures different from each other and the surface temperature of at least the area A is a surface temperature that is higher than or equal to a temperature T of an inflection point of orientation returning strength of the resin sheet and a step (2) of attaching the resin sheet to an adherend by vacuum forming to achieve integration.

Specifically, a conventional thermoforming machine used for vacuum forming, vacuum pressure forming, or the like is employed. In the present invention, since the step (1) and the step (2) are continuously performed, a thermoforming machine equipped with infrared irradiation means is preferred.

### (Step 1 Support)

In the step 1, as described above, the supported state means a state in which only part or all of the periphery of the resin sheet S is secured, that is, a state in which the surface of the sheet S to be attached to the adherend is not at all supported by a substrate or the like. Specifically, there can be employed a method in which part of the resin sheet S is secured by clamping or the like or a method in which the entire circumference of the resin sheet S is secured using a frame-shaped clamp. Herein, the method in which the entire circumference of a sheet is secured using a frame-shaped clamp is preferably employed because the tension of the resin sheet S can be optimized (equalized).

The securing herein can be achieved by preventing plasticization and shrinkage of the resin sheet S, in addition to the securing method that uses a jig such as a frame-shaped clamp. Specifically, the securing can be achieved by keeping the sheet temperature of a portion of the resin sheet S other than the surface to be attached to the adherend, preferably a peripheral portion of the sheet, lower than or equal to the glass transition temperature (hereinafter may be referred to as Tg) to prevent plasticization.

### (Step 1 Infrared Rays)

By applying infrared rays while the resin sheet S is supported so that the surface temperature of at least the area A is a surface temperature that is higher than or equal to a temperature T of an inflection point of orientation returning strength of the resin sheet, the area A and the area B are heated to different surface temperatures. As a result, the difference in thickness is created between the area A and the area B.

The infrared rays applied herein are not particularly limited as long as the infrared rays are laser beams having a wavelength in red, near-infrared, and infrared regions. The upper limit of the infrared rays applied is not particularly limited. However, an excessively large amount of heat decreases the rigidity of the resin sheet S and the plasticization is promoted, which may hinder the molding due to tears or the like. Therefore, the amount of infrared rays applied is preferably set so that the area of the resin sheet S used, the area having the highest temperature, preferably has a storage modulus (E′) of dynamic viscoelasticity measurement of 0.5 MPa or more and more preferably 1 MPa or more, the storage modulus being measured in accordance with JIS K 7244-1.

In many cases, a conventional thermoforming machine used for vacuum forming, vacuum pressure forming, or the like is preferably employed because an infrared radiation device as heating means can be disposed in or outside such a thermoforming machine. Since the infrared radiation device needs to perform irradiation with infrared rays having a wavelength that is absorbed by only a heat-generating substance, a halogen heater, a short wave heater, a carbon heater, a mid-infrared heater, or the like having a strong wavelength peak in mid-infrared to near-infrared regions is preferably used. The peak of the main wavelength of such an infrared radiation device is preferably within 1.0 to 3.5 μm and more preferably within 1.5 to 3.0 μm because an efficient thickness difference can be created and thus an adequate difference in temperature is created between a heat-absorbing substance and other areas, whereby manufacturing can be efficiently performed.

An infrared radiation device disposed as heating means often operates on the basis of temperature control. In the present invention, the amount of infrared rays applied is evaluated from not the amount of infrared rays applied, but the surface temperatures of the area A and the area B of the resin sheet S obtained as a result of application of infrared rays.

The minimum amount of infrared rays applied is set so that the surface temperature of at least the area A of the resin sheet S is a surface temperature that is higher than or equal to a temperature T of an inflection point of orientation returning strength of the resin sheet. On the other hand, when the temperature of the area A is excessively high, the plasticization of the area A is promoted, which may cause defects such as hole opening. Therefore, the maximum amount of infrared rays applied is set so that E′ obtained by dynamic viscoelasticity measurement of the area A is preferably 0.5 MPa or more and more preferably 1.0 MPa or less.

The infrared rays are preferably applied under vacuum. In typical vacuum forming, heating is performed through irradiation with infrared rays in an atmospheric pressure. However, in the present invention, it was found that, by performing irradiation with infrared rays under vacuum, a larger difference in thickness can be effectively created at a certain temperature. This may be because infrared rays efficiently reach the resin sheet S and inks without being affected by heat conduction of the air. Conversely, it is assumed that, since there is almost no ambient heated air, excess heat does not easily conduct to the area A and the area B.

After that, an unnecessary portion may be optionally trimmed. The trimming method is not particularly limited, and trimming can be performed by a cutting method that uses scissors or a cutter, a die cutting method, a laser cutting method, a water jet method, or a punching-blade pressing method.

### (Adherend)

The adherend used in the present invention is not particularly limited, and any adherend may be used as long as it is transparent or opaque and requires a surface design. Specifically, various shaped materials composed of resin, metal, glass, wood, paper, or the like can be used, and the shaped materials may have been decorated by a typical decoration method such as coating, plating, or scratching.

When an adherend is composed of a resin molding having transparency or semitransparency, the adherend is seen through the resin sheet S and thus a deep color tone can be provided. A resin molding having semitransparency or opacity is normally obtained by molding a resin containing a coloring agent. The coloring agent is not particularly limited. Conventional inorganic pigments, organic pigments, and dyes used to color a typical thermoplastic resin can be used as the coloring agent depending on the intended design. Examples of the coloring agent include inorganic pigments such as titanium oxide, titan yellow, iron oxide, composite oxide-based pigments, ultramarine blue, cobalt blue, chromium oxide, bismuth vanadate, carbon black, ivory black, peach black, lampblack, bitumen, graphite, iron black, titanium black, zinc oxide, calcium carbonate, barium sulfate, silica, and talc; organic pigments such as azo-based pigments, phthalocyanine-based pigments, quinacridone-based pigments, dioxazine-based pigments, anthraquinone-based pigments, isoindolinone-based pigments, isoindoline-based pigments, perylene-based pigments, perynone-based pigments, quinophthalone-based pigments, thioindigo-based pigments, and diketopyrrolopyrrole-based pigments; and metal complex pigments. Regarding dyes, one or two dyes mainly selected from the group of oil-soluble dyes are preferably used.

The resin used is also not particularly limited. Examples of the resin include polyolefin resin such as polyethylene or polypropylene; polyester resin such as polyethylene terephthalate or polybutylene terephthalate; acrylic resin such as polymethyl methacrylate or polyethyl methacrylate; styrene resin such as polystyrene, acrylonitrile-butadiene-styrene resin, acrylonitrile-acrylic rubber-styrene resin, acrylonitrile-ethylene rubber-styrene resin, (meth)acrylic acid ester-styrene resin, or styrene-butadiene-styrene resin; polyamide resin such as ionomer resin, polyacrylonitrile, or nylon; chlorine-based resin such as ethylene-vinyl acetate resin, ethylene-acrylic acid resin, ethylene-ethyl acrylate resin, ethylene-vinyl alcohol resin, polyvinyl chloride, or polyvinylidene chloride; fluorine-based resin such as polyvinyl fluoride or polyvinylidene fluoride; polycarbonate resin; modified-polyphenylene ether resin; methylpentene resin; cellulose resin; and thermoplastic elastomer such as olefin-based elastomer, vinyl chloride-based elastomer, styrene-based elastomer, urethane-based elastomer, polyester-based elastomer, or polyamide-based elastomer. Two or more types of the resins may be used in a mixed manner or in a multi-layered manner. Furthermore, typical additives such as a reinforcing agent, e.g., an inorganic filler, a plasticizer, an antioxidant, an ultraviolet absorber, an antistatic agent, a fire retardant, and a lubricant may be added, and such additives my be used alone or in combination.

### Examples

The present invention will now be described based on Examples. Herein, “parts” and “%” are expressed on a mass basis unless otherwise specified.

### (Resin Sheet S)

The following six sheets were used as the resin sheet S.

Sheet S0: Biaxially stretched PET sheet “Softshine X1130” manufactured by TOYOBO CO., LTD. (thickness: 188 μm)
Sheet S1: Biaxially stretched PET sheet “Softshine X1130” manufactured by TOYOBO CO., LTD. (thickness: 125 μm)
Sheet S2: Biaxially stretched PET sheet “Teflex FT3PE” manufactured by Teijin DuPont Films Japan Limited (thickness: 50 μm)
Sheet S3: Biaxially stretched polystyrene sheet (250 μm) “After Polystyrene CR-4500 manufactured by DIC Corporation was extruded at 210° C. using an extruder, a non-stretched original film was formed using a T-die. Subsequently, the original film was stretched at 130° C. to obtain a stretched sheet having a thickness of 250 μm and having a heat shrinkage stress of 0.4 MPa in the MD direction and 0.5 MPa in the TD direction”
Sheet S4: Uniaxially stretched sheet “Technolloy S001” manufactured by Sumitomo Chemical Co., Ltd. (thickness: 125 μm)
Sheet S5: Non-stretched sheet “A-PET PT700M” manufactured by Polytech Co. (thickness: 250 μm)

### (Measurement Method of Temperature T of Inflection Point of Orientation Returning Strength)

The temperature T of an inflection point of orientation returning strength of the resin sheet S was measured as follows. Orientation returning stress at each temperature was measured using a D. N-type stress tester manufactured by Nichiri Kogyo co. by increasing the temperature of a heater in 5° C. increments at a voltage regulating scale of 6. The temperature T of an inflection point of orientation returning strength was read.

The results are shown below.
Temperature T of inflection point of orientation returning strength of the sheet S0: 188° C.
Temperature T of inflection point of orientation returning strength of the sheet S1: 188° C.
Temperature T of inflection point of orientation returning strength of the sheet S2: 170° C.
Temperature T of inflection point of orientation returning strength of the sheet S3: 109° C.
Temperature T of inflection point of orientation returning strength of the sheet S4: 110° C.
Temperature T of inflection point of orientation returning strength of the sheet S5: none

### (Infrared Absorption Ink or Infrared Reflection Ink)

The following inks were used as an infrared absorption ink, an infrared reflection ink, and a color ink.

Ink P1: “Paint Marker” Black manufactured by MITSUBISHI PENCIL CO., LTD., which was used as an infrared absorption ink
Ink P2: “Paint Marker” Silver manufactured by MITSUBISHI PENCIL CO., LTD., which was used as an infrared reflection ink
Ink P3: “Paint Marker” Blue manufactured by MITSUBISHI PENCIL CO., LTD., which was used as a color ink
Ink G1: Gravure ink “XS-756” Black manufactured by DIC Corporation, which was used as an infrared absorption ink containing 40 mass % carbon black relative to the total solid content
Ink G2: Gravure ink “XS-756” Silver manufactured by DIC Corporation, which was used as an infrared reflection ink containing 13 mass % aluminum paste relative to the total solid content
Ink G3: Gravure ink “NH-NT(A)” White manufactured by DIC Graphics Corporation, which was used as an infrared absorption ink containing 50 mass % titanium oxide relative to the total solid content
Ink G4: An ink obtained by diluting Gravure ink “XS-756” Black manufactured by DIC Corporation with XS-756 medium ink so as to contain 18 mass % carbon black relative to the total solid content, the ink being used as an infrared absorption ink
Ink GH1: Gravure ink “XS-756” Red manufactured by DIC Corporation, which was used as a color ink
Ink GH2: Gravure ink “XS-756” Blue manufactured by DIC Corporation, which was used as a color ink
Ink GH3: Gravure ink “XS-756” Yellow manufactured by DIC Corporation, which was used as a color ink
Ink GH4: Gravure ink “XS-756” Pearl color manufactured by DIC Corporation, which was used as a color ink

Note that the ink G2 increases a surface temperature higher than the ink G1.

### (Method for Printing Pattern)

A pattern having a thickness of 3 μm was printed on the resin sheet S with a four-color gravure printer using the inks G1 to G4 and GH1 to GH4.

Furthermore, a straight line was drawn on the resin sheet S by handwriting using the inks P1 to P3.

### (Confirmation of Creation of Difference in Thickness in Step (1))

A straight line having a width of 2 mm was drawn on any of the sheets S0 to S5 used as the resin sheet S in the machine direction (MD) and in the cross direction (CD) using the inks P1 to P3. With “NGF-0709 Molding Machine” manufactured by Fu-se Vacuum Forming and described below, the resin sheet S was indirectly heated from the side opposite the surface having the straight line drawn thereon using, as a heater, a mid-infrared heater manufactured by Heraeus K.K. under vacuum while the periphery of the sheet was completely secured with a clamp.

After it was confirmed using a radiation thermometer FT-H30 manufactured by KEYENCE Corporation that the surface temperature of the resin sheet S was increased to the set temperature of the heater, the resin sheet S was cooled to room temperature and the clamp was removed to obtain a sample.

The surface temperatures of the area A including ink and the area B including no ink were measured with Thermo Tracer 9100 manufactured by NEC Avio Infrared Technologies Co., Ltd. That is, when the temperature of the area A reached the temperature T of an inflection point of orientation returning strength of the resin sheet S used, the difference in temperature/° C. between the area A and the area B was measured. Furthermore, when the surface temperature of the resin sheet S used was increased to the set temperature of the heater (the temperature is normally a temperature that allows thermoforming), the temperatures of the area A and the area B were measured.

The thickness of the area A and the area B was measured using K351C manufactured by Anritsu Corporation. Regarding the difference in elevation, the maximum difference in thickness between the area A and the area B was measured using a surface roughness meter SURFCOM ver. 1.71 manufactured by TOKYO SEIMITSU CO., LTD.

Hereinafter, Examples 1 to 7 and Comparative Examples 1 to 4 were obtained by suitably changing the combination of the sheets S0 to S5 and the inks P1 to P3 in accordance with Table 1.

Tables 1-1, 1-2, and 2 show the results.

TABLE 1-1

| | | Ex. 1 | Ex. 2 | Ex. 3 | Ex. 4 | Ex. 5 |
|---|---|---|---|---|---|---|
| Type of resin sheet S | | Sheet S0 | Sheet S0 | Sheet S1 | Sheet S4 | Sheet S0 |
| Temperature T of inflection point of | | 188° C. | 188° C. | 188° C. | 110° C. | 188° C. |
| orientation returning strength of resin | | | | | | |
| sheet S | | | | | | |
| Ink | | Ink P1 | Ink P1 | Ink P2 | Ink P1 | Ink P1 |
| Spreading factor % | | 100 | 100 | 100 | 100 | 100 |
| Set temperature of heater/° C. | | 180 | 190 | 180 | 155 | 195 |
| Difference in temperature between area A | | 13 (difference in | 13 (difference in | 30 (difference in | 9 (difference in | 13 (difference in |
| and area B when temperature of area A | | temperature when | temperature when | temperature when | temperature when | temperature when |
| reached temperature T of inflection point | | temperature of | temperature of | temperature of | temperature of | temperature of |
| of orientation returning strength of resin | | area A reached | area A reached | area A reached | area A reached | area A reached |
| sheet S used/° C. | | 188° C.) | 188° C.) | 188° C.) | 110° C.) | 188° C.) |
| Surface | Area A | 196 | 206 | 227 | 168 | 213 |
| temperature of | Area B | 183 | 198 | 180 | 157 | 211 |
| resin sheet S/° C. | Difference in | 13 | 8 | 47 | 9 | 2 |
| | temperature | | | | | |
| Thickness of resin | Area A | 152 | 84 | 67 | 87 | 70 |
| sheet S/μm | Area B | 195 | 209 | 130 | 112 | 231 |
| | Difference in | 43 | 125 | 63 | 25 | 161 |
| | thickness | | | | | |
| E′ MPa | Area A | 28 | 20 | 4.9 | 2 | 17 |
| | Area B | 39 | 25 | 42 | 2.8 | 18 |

Ex.: Example

TABLE 1-2

| | | Ex. 6 | Ex. 7 |
|---|---|---|---|
| Type of resin sheet S | | Sheet S2 | Sheet S3 |
| Temperature T of inflection point | | 170° C. | 109° C. |
| of orientation returning strength | | | |
| of resin sheet S | | | |
| Ink | | Ink P1 | Ink P2 |
| Spreading factor % | | 100 | 100 |
| Set temperature of heater/° C. | | 170 | 90 |
| Difference in temperature | | 15 | 18 |
| between area A and area B when | | (difference in | (difference in |
| temperature of area A reached | | temperature | temperature |
| temperature T of inflection point | | when temper- | when temper- |
| of orientation returning strength | | ature of area A | ature of area A |
| of resin sheet S used/° C. | | reached 170° C.) | reached 109° C.) |
| Surface | Area A | 184 | 133 |
| temperature of | Area B | 174 | 112 |
| resin sheet S/° C. | Difference in | 7 | 21 |
| | temperature | | |
| Thickness of resin | Area A | 40 | 241 |
| sheet S/μm | Area B | 25 | 149 |
| | Difference in | 15 | 92 |
| | thickness | | |
| E′ MPa | Area A | 6.3 | 1.1 |
| | Area B | 10 | 28 |

Ex.: Example

TABLE 2

| | | C.E. 1 | C.E. 2 | C.E. 3 | C.E. 4 |
|---|---|---|---|---|---|
| Type of resin sheet S | | Sheet S0 | Sheet S4 with | Sheet S0 | Sheet S5 |
| | | | glass plate | | |
| Temperature T of inflection point of | | 188° C. | 110° C. | 188° C. | None |
| orientation returning strength of resin | | | | | |
| sheet S | | | | | |
| Ink | | Ink P1 | Ink P1 | Ink P3 | Ink P2 |
| Spreading factor % | | 100 | 100 | 100 | 100 |
| Set temperature of heater/° C. | | 175 | 155 | 190 | 100 |
| Difference in temperature between area A | | 13 | 9 | 5 | — |
| and area B when temperature of area A | | (difference in | (difference in | (difference in | |
| reached temperature T of inflection point | | temperature | temperature | temperature | |
| of orientation returning strength of resin | | when temper- | when temper- | when temper- | |
| sheet S used/° C. | | ature of area A | ature of area A | ature of area A | |
| | | reached 188° C.) | reached 110° C.) | reached 188° C.) | |
| Surface | Area A | 185 | 166 | 203 | 121 |
| temperature of | Area B | 175 | 157 | 198 | 100 |
| resin sheet S/° C. | Difference in | 10 | 9 | 5 | 21 |
| | temperature | | | | |
| Thickness of resin | Area A | 201 | 427 | 212 | 243 |
| sheet S/μm | Area B | 196 | 430 | 215 | 239 |
| | Difference in | 5 | 3 | 3 | 4 |
| | thickness | | | | |
| E′ MPa | Area A | 48 | 40 | 22 | 6.5 |
| | Area B | 48 | 45 | 25 | 8.0 |

C.E.: Comparative Example

As a result, in Examples 1 to 7, satisfactory projections and depressions were formed.

Comparative Example 1 was an example in which the temperature of the area A was lower than the temperature of an inflection point of orientation returning strength of the sheet. In Comparative Example 1, projections and depressions were not formed.

In Comparative Example 2, a glass plate with a thickness of 500 μm was attached to the entire surface of the sheet S4. Despite the fact that the temperature of the area A was higher than the temperature of an inflection point of orientation returning strength of the sheet, projections and depressions were not formed.

In Comparative Example 3, a color ink was used. Despite the fact that the temperature of the area A reached a temperature that is higher than or equal to the temperature of a starting point of orientation returning, projections and depressions were not formed.

Comparative Example 4 was an example in which the sheet S5 having no heat-shrinkable property (having no temperature of an inflection point of orientation returning strength) was used. The set temperature of the heater was a temperature that is higher than the thermosoftening point of the sheet S5. Although molding was supposed to be performed without problems at that temperature, projections and depressions were not formed.

### (Method for Simultaneously Performing Vacuum Forming and Attachment)

Thermoforming was performed with “NGF-0709 Molding Machine” manufactured by Fu-se Vacuum Forming.

The periphery of the resin sheet S on which a pattern having a thickness of 3 μm was printed using a four-color gravure printer was completely secured with a clamp. The upper and lower boxes of a molding machine were closed and the boxes were brought into a substantially perfect vacuum state. The resin sheet S was indirectly heated from the upper surface thereof using, as a heater, a mid-infrared heater manufactured by Heraeus K.K. to increase the surface temperature of the resin sheet S to the set temperature. A table having the adherend placed thereon was elevated, and compressed air with 0.2 MPa was blown into the upper box. Thus, the resin sheet S was attached to the adherend to achieve integral molding.

The surface temperature distribution of the resin sheet S during vacuum forming cannot be measured because of its vacuum state. Therefore, an opening was formed in the lower box of the molding machine, and the surface temperature distribution was measured using Thermo Tracer TH9100 manufactured by NEC Avio Infrared Technologies Co., Ltd. The heater started to increase the temperature before molding, and the temperature of the heater finally reached about 900 to 930° C.

Furthermore, whether the surface temperature of the resin sheet S reached the set temperature was determined using a radiation thermometer FT-H30 manufactured by KEYENCE Corporation.

The distance between the heater and the resin sheet S was about 250 mm. A flat board having a length of 80 mm, a width of 150 mm, and a thickness of 2 mm was used as the adherend so that the difference in thickness could be measured.

### Examples 8 to 13

### Method for Manufacturing Decorated Molding

The sheet S1 was used as the resin sheet S. A predetermined pattern was printed by gravure printing using any of the inks G1 to G4 and GH1 to GH4 (pattern-printing plates were as follows. Example 8: refer to FIGS. 8 and 9, Example 9: refer to FIGS. 10 and 11, Example 10: refer to FIGS. 12 and 13, Example 11: refer to FIGS. 14 and 15, Example 12: refer to FIGS. 17 and 18, Example 13: refer to FIGS. 8 and 9).

Decorative molding to the flat board was conducted by the method for simultaneously performing vacuum forming and attachment using the sheet S1 on which a pattern was printed. The maximum value of the difference between projections and depressions of the resultant decorated molding was measured. Tables 3-1 and 3-2 show the results.

In all the cases, decorated moldings were obtained on which clear projections and depressions were formed in the areas patterned using the inks G1 to G4.

In Example 8 in which printing was performed on the sheet S1 using two plates of the ink G1 and GH2 (this is an example in which there are the area A having a pattern formed with the infrared absorption ink or the infrared reflection ink and the area B having no pattern), only the printed area with the ink G1 containing carbon black, which was a heat-generating substance T1, became a depression.

In Example 9 in which printing was performed using two plates of the ink G2 (this is an example in which there are the area A having a high ink concentration and the area B having a low ink concentration, and the overlapped area of the two plates corresponds to the area A and the area in which printing was performed using one plate corresponds to the area B), the area A that was an overlapped area of the two plates became a depression.

In Example 10 in which printing was performed on the sheet S1 using four plates of the inks G1, GH1, GH2, and GH4 (this is an example in which there are the area A having a pattern formed with the infrared absorption ink or the infrared reflection ink and the area B having no pattern), only the printed area with the ink G1 became a depression.

In Example 11 in which printing was performed using four plates of the inks G1, GH1, GH2, and GH3 (this is an example in which there are the area A having a high ink concentration and the area B having a low ink concentration, and, as shown in FIGS. 14 and 15, overprinting was partly performed using the ink G1 (8-2 in FIGS. 14 and 15). The overprinted area denoted by 8-2 in FIGS. 14 and 15 corresponds to the area A and the area denoted by 8 in FIGS. 14 and 15 in which printing was performed using one plate corresponds to the area B), only the printed area with the ink G1 became a depression and the overprinted area with the ink G1 (8-2 in FIGS. 14 and 15) became a larger depression.

In Example 12 in which printing was performed by changing only the ink GH2 among the inks in Example 11 to the ink G4 (this is an example in which there are the area A (8 and 8-2 in FIGS. 17 and 18) having a pattern formed using the ink G1 with a high infrared absorptance and the area B (14 in FIGS. 17 and 18) having a pattern formed using the ink G4 with a low infrared absorptance), the area (8 in FIGS. 17 and 18) in which printing was performed using one plate of the ink G1 became a depression having a difference in thickness of 42 μm, the printed area with the ink G4 (14 in FIGS. 17 and 18) became a small depression having a difference in thickness of 22 μm, and the overprinted area with the ink G1 (8-2 in FIGS. 17 and 18) became a large depression having a difference in thickness of 147 μm.

Regarding the amount of infrared absorption (ABS) at 4000 cm⁻¹, which corresponds to a mid-infrared wavelength, measured by an ATR method using FTIR-4200 manufactured by JASCO Corporation, the value of the ink G1 was 8.6 and the value of the ink G4 was 4.9.

In Example 13 in which printing was performed on the sheet S1 using two plates of the ink G3 and the ink GH2 (this is an example in which there are the area A having a pattern formed with the infrared absorption ink or the infrared reflection ink and the area B having no pattern), only the printed area with the ink G3 containing titanium oxide, which was a heat-generating substance T1, became a depression.

TABLE 3-1

| | | Ex. 8 | Ex. 9 | Ex. 10 | Ex. 11 |
|---|---|---|---|---|---|
| Type of resin sheet S | | Sheet S1 | Sheet S1 | Sheet S1 | Sheet S1 |
| Configuration of printing plates | | Two plates | Two plates | Four plates | Four plates |
| Ink | | G1, GH2 | G2 | G1, GH1, GH2, | G1, GH1, GH2, |
| | | | | GH4 | GH3 |
| Spreading factor % | | 100 | 100 | 100 | 100 |
| Set temperature of heater/° C. | | 185 | 185 | 185 | 180 |
| Difference in temperature between area A | | 12 | 10 | 11 | 13 |
| and area B when temperature of area A | | (difference in | (difference in | (difference in | (difference in |
| reached temperature T of inflection point | | temperature | temperature | temperature | temperature |
| of orientation returning strength of resin | | when temper- | when temper- | when temper- | when temper- |
| sheet S used/° C. | | ature of area A | ature of area A | ature of area A | ature of area A |
| | | reached 188° C.) | reached 188° C.) | reached 188° C.) | reached 188° C.) |
| Surface | Area A | 211 | 205 | 212 | 220 |
| temperature of | Area B | 198 | 197 | 199 | 197 |
| resin sheet S/° C. | Difference in | 13 | 8 | 13 | 23 |
| | temperature | | | | |
| Thickness of resin | Area A | 81 | 75 | 81 | 103 |
| sheet 5/μm | Area B | 133 | 126 | 192 | 250 |
| | Difference in | 52 | 51 | 111 | 147 |
| | thickness | | | | |

Ex.: Example

TABLE 3-2

| | | Ex. 12 | Ex. 13 |
|---|---|---|---|
| Type of resin sheet S | | Sheet S1 | Sheet S1 |
| Configuration of printing plates | | Four plates | Two plates |
| Ink | | G1, GH1 , G4, | G3, GH2 |
| | | GH3 | |
| Spreading factor % | | 100 | 100 |
| Set temperature of heater/° C. | | 180 | 185 |
| Difference in temperature | | 13 | 8 |
| between area A and area B when | | (difference in | (difference in |
| temperature of area A reached | | temperature | temperature |
| temperature T of inflection point | | when temper- | when temper- |
| of orientation returning strength | | ature of area A | ature of area A |
| of resin sheet S used/° C. | | reached 188° C.) | reached 188° C.) |
| Surface | Area A | 220 | 204 |
| temperature of | Area B | 197 | 198 |
| resin sheet S/° C. | Difference in | 23 | 6 |
| | temperature | | |
| Thickness of resin | Area A | 103 | 92 |
| sheet S/μm | Area B | 250 | 116 |
| | Difference in | 147 | 24 |
| | thickness | | |

Ex.: Example

### Examples 14 and 15

### Method for Manufacturing Decorated Moldings Having Different Spreading Factors

The pattern shown in FIG. 8 was printed on the sheet S1 by gravure printing using the ink G1 and the ink GH2. The resultant sheet S1 was attached to a flat board through decorative molding at different spreading factors by the method for simultaneously performing vacuum forming and attachment. The maximum value of the difference between projections and depressions of the resultant decorated molding was measured. Table 4 shows the results. In both cases, decorated moldings having clear projections and depressions were obtained.

The spreading factor was adjusted to 100% (non-stretched), 160%, and 290% by disposing the adherend in a female-type box-shaped die and changing the depth of the adherend.

TABLE 4

| | | Ex. 14 | Ex. 15 |
|---|---|---|---|
| Type of resin sheet S | | Sheet S1 | Sheet S1 |
| Configuration of printing plates | | Two plates | Two plates |
| Ink | | G1, GH2 | G1, GH2 |
| Spreading factor % | | 160 | 290 |
| Set temperature of heater/° C. | | 185 | 185 |
| Surface temperature | Area A | 211 | 210 |
| of resin sheet S/° C. | Area B | 198 | 198 |
| | Difference in | 13 | 12 |
| | temperature | | |
| Thickness of resin | Area A | 45 | 25 |
| sheet S/μm | Area B | 86 | 47 |
| | Difference in | 41 | 22 |
| | thickness | | |

Ex.: Example

### Example 16

### Method for manufacturing decorated molding Including Surface Protective Layer

The pattern shown in FIG. 8 was printed on a surface of the sheet S1 having a surface protective layer (hereinafter referred to as TP) formed thereon, the surface being opposite the surface protective layer, by gravure printing using the ink G1 or the ink GH2. The resultant sheet S1 was attached to a flat board through decorative molding by the method for simultaneously performing vacuum forming and attachment. Table 5 shows the results.

### (Surface Protective Layer)

The surface protective layer was formed by mixing a copolymer containing a hydroxyl group and a polyisocyanate compound at a ratio of 1:1 and by applying the mixture so as to have a thickness of 10 μm.

### (Copolymer Containing Hydroxyl Group)

A mixed solution of 850 parts of butyl acetate and 1 part of Perbutyl Z (product name, t-butyl peroxybenzoate manufactured by NOF CORPORATION) was heated to 110° C. A mixed solution of 660 parts of methyl methacrylate, 150 parts of t-butyl methacrylate, and 190 parts of 2-hydroxyethyl methacrylate and a mixed solution of 200 parts of isobutyl acetate, 9 parts of Perbutyl Z (product name, t-butyl peroxy-2-ethylhexanoate manufactured by NOF CORPORATION), and 2 parts of Perbutyl Z (product name, t-butyl peroxybenzoate manufactured by NOF CORPORATION) were added dropwise to the above-described mixed solution in a nitrogen atmosphere over a period of five hours. The resultant mixture was stirred for fifteen hours to obtain a copolymer containing a hydroxyl group and having a solid content of 60%. The weight-average molecular weight of the obtained resin was 100,000, the hydroxyl value of the solid content was 79 KOH mg/g, and the glass transition temperature Tg was 95° C. Herein, the weight-average molecular weight is a polystyrene equivalent value obtained by GPC measurement, the hydroxyl value is calculated as the amount of KOH neutralization for a prepared monomer composition, and the polymer Tg is a value measured with a DSC.

### (Polyisocyanate Compound)

Polyisocyanate containing an isocyanurate ring “BURNOCK DN-981” (product name, manufactured by DIC Corporation, number-average molecular weight: about 1000, non-volatile content: 75% (solvent: ethyl acetate), the number of functional groups: 3, NCO concentration: 13 to 14%) was used as the polyisocyanate compound.

TABLE 5

| | | Ex. 16 |
|---|---|---|
| Type of resin sheet S | | Sheet S1 |
| Configuration of printing plates | | Two plates |
| Ink | | G1, GH2 |
| Spreading factor % | | 100 |
| Set temperature of heater/° C. | | 185 |
| Surface temperature | Area A | 211 |
| of resin sheet S/° C. | Area B | 199 |
| | Difference in | 12 |
| | temperature | |
| Thickness of resin | Area A | 91 |
| sheet S/μm | Area B | 129 |
| | Difference in | 38 |
| | thickness | |

Ex.: Example

### Comparative Example 4

### Example that does not Use Infrared Rays as Heat Source

A decorated molding was obtained in the same manner as in Example 8, except that the resin sheet S was inserted, for five minutes, into a gear oven GPHH-100 that was manufactured by TABAI ESPEC Corporation and was being heated at a predetermined temperature, the gear oven being used as a heat source. As a result, the difference in thickness was not created and a decorated molding having projections and depressions was not obtained.

TABLE 6

| | | C.E. 4 |
|---|---|---|
| Type of resin sheet S | | S1 |
| Configuration of printing plates | | Two plates |
| Ink | | G1, GH2 |
| Spreading factor % | | 100 |
| Heating mode | | Hot air |
| Set temperature of heater/° C. | | 185 |
| Surface temperature | Area A | 198 |
| of resin sheet S/° C. | Area B | 198 |
| | Difference in | 0 |
| | temperature | |
| Thickness of resin | Area A | 131 |
| sheet S/μm | Area B | 133 |
| | Difference in | 2 |
| | thickness | |

C.E.: Comparative Example

### BRIEF DESCRIPTION OF DRAWINGS

FIG. 1 is a diagram showing a specific embodiment that illustrates the state in which a heat-shrinkable resin sheet having a pattern printed thereon with an infrared absorption ink is irradiated with infrared rays using an infrared heater.

FIG. 2 is a diagram showing the state of a resin sheet obtained after the resin sheet is irradiation with infrared rays while being supported.

FIG. 3 is a diagram showing the state in which the resin sheet shown in FIG. 2 is attached to an adherend by vacuum forming to achieve integration.

FIG. 4 shows an example of a pattern-printed layer used in the present invention. The black portion is the printed layer (stripe).

FIG. 5 shows an example of a pattern-printed layer used in the present invention. The black portion is the printed layer (dot).

FIG. 6 shows an example of a pattern-printed layer used in the present invention. The black portion is the printed layer (geometric pattern).

FIG. 7 shows an example of a pattern-printed layer used in the present invention. The black portion is the printed layer (grain).

FIG. 8 is a schematic view of a resin sheet S on which printing has been performed and that is used in Examples 8 and 13. The upper part is a plan view and the lower part is a sectional view in a black frame of the plan view.

FIG. 9 is a schematic sectional view of a decorated molding of Examples 8 and 13.

FIG. 10 is a schematic view of a resin sheet S on which printing has been performed and that is used in Example 9. The upper part is a plan view and the lower part is a sectional view in a black frame of the plan view.

FIG. 11 is a schematic sectional view of a decorated molding of Example 9.

FIG. 12 is a schematic view of a resin sheet S on which printing has been performed and that is used in Example 10. The upper part is a plan view and the lower part is a sectional view in a black frame of the plan view.

FIG. 13 is a schematic sectional view of a decorated molding of Example 10.

FIG. 14 is a schematic view of a resin sheet S on which printing has been performed and that is used in Example 11. The upper part is a plan view and the lower part is a sectional view in a black frame of the plan view.

FIG. 15 is a schematic sectional view of a decorated molding of Example 11.

FIG. 16 is a graph showing orientation returning strength as a function of temperature, the orientation returning strength being obtained by measuring a biaxially stretched PET sheet “Softshine X1130 (thickness: 125 μm)” manufactured by TOYOBO CO., LTD. (sheet S1 in Examples) in accordance with ASTM D-1504.

FIG. 17 is a schematic view of a resin sheet S on which printing has been performed and that is used in Example 12. The upper part is a plan view and the lower part is a sectional view in a black frame of the plan view.

FIG. 18 is a schematic sectional view of a decorated molding of Example 12.

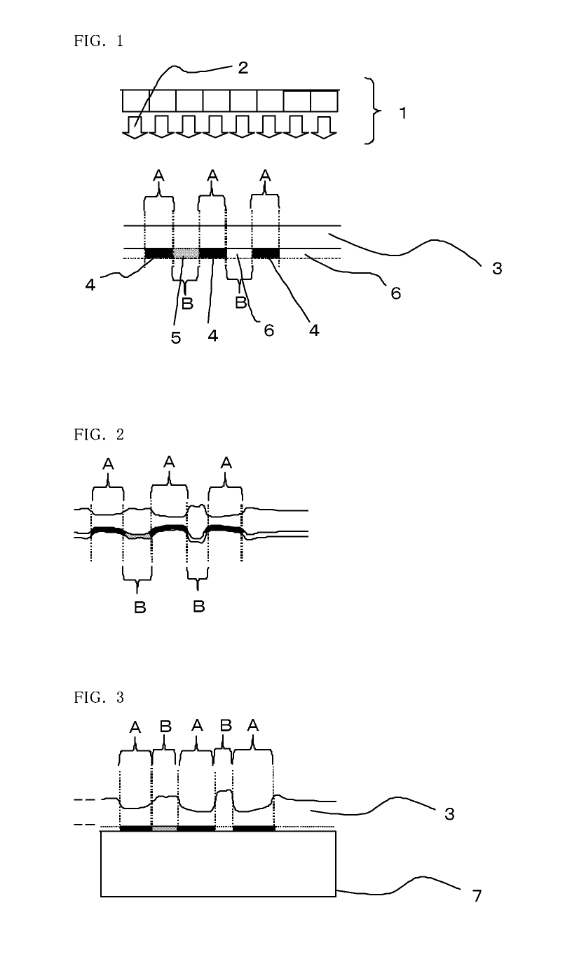

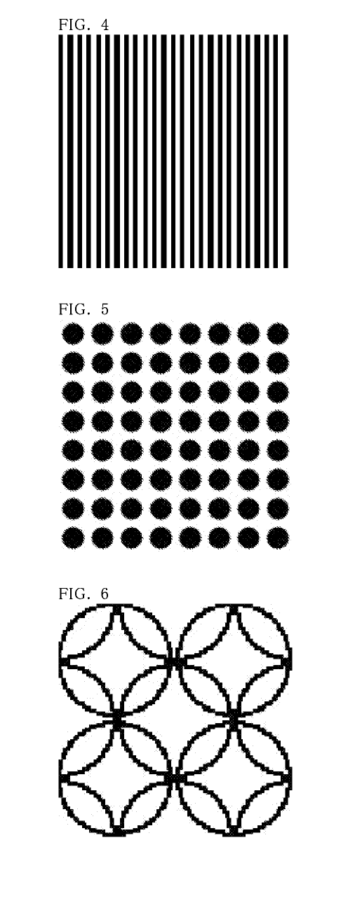

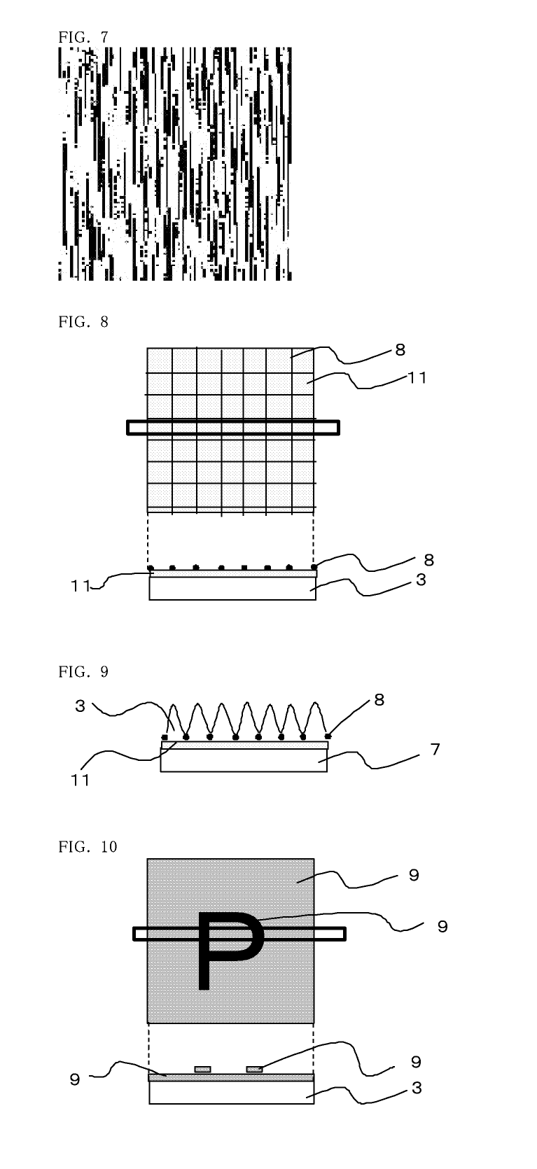

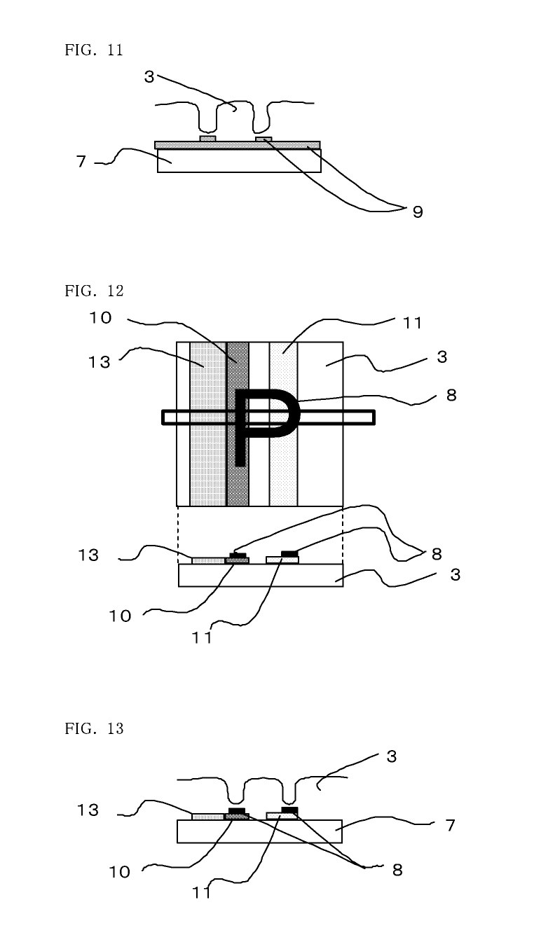

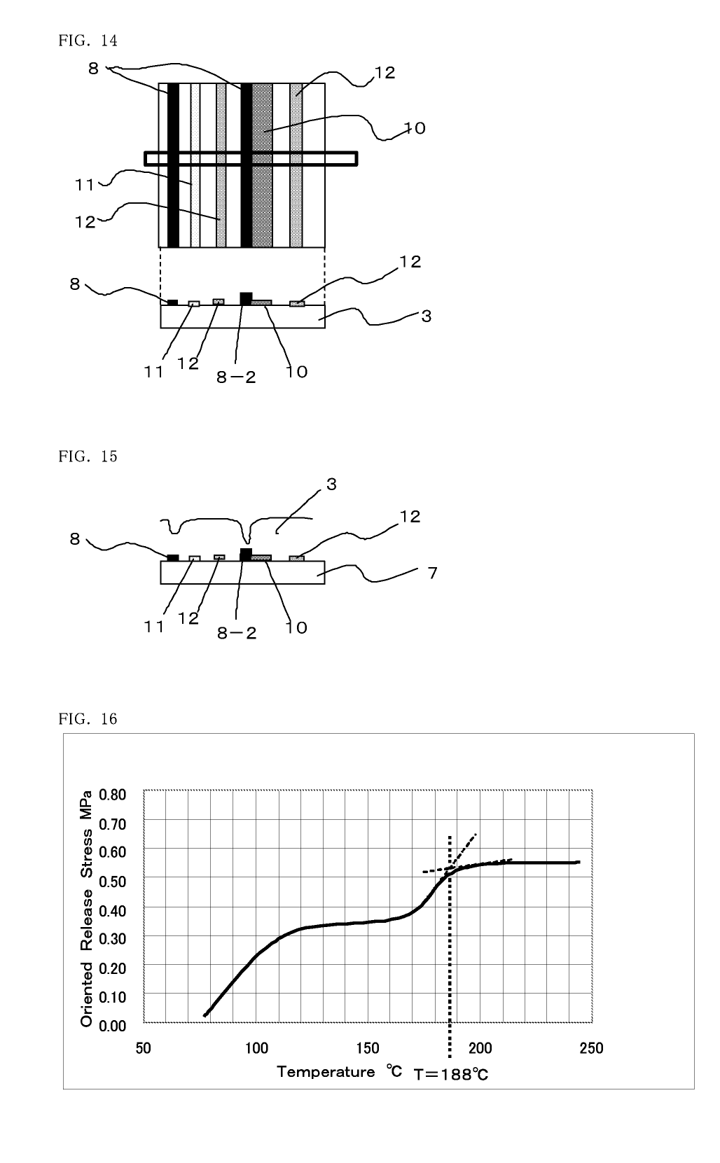

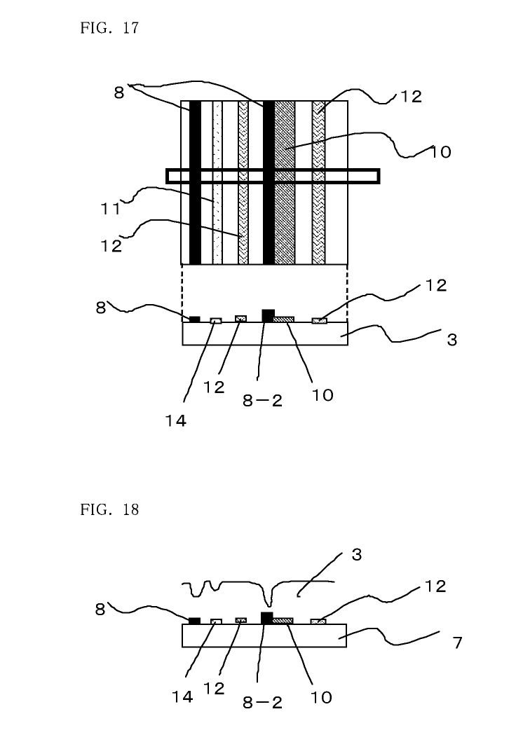

### REFERENCE SIGNS LIST

1 infrared heater
2 infrared rays
3 heat-shrinkable resin sheet
4 printed area with infrared absorption ink having high concentration
5 printed area with infrared absorption ink having low concentration
6 printed area with color ink (that does not absorb infrared rays)
7 adherend
8 ink G1 or G3
9 ink G2
10 ink GH1
11 ink GH2
12 ink GH3
13 ink GH4
14 ink G4

1. A method for manufacturing a decorated molding having projections and depressions in a decorated surface, the method comprising, while a heat-shrinkable resin sheet is supported:
a step (1) of creating a difference in thickness between an area A and an area B adjacent to each other in the same plane of the resin sheet through irradiation with infrared rays so that the area A and the area B have surface temperatures different from each other and the surface temperature of at least the area A is a surface temperature that is higher than or equal to a temperature T of an inflection point of orientation returning strength of the resin sheet; and
a step (2) of attaching the resin sheet to an adherend by vacuum forming to achieve integration.

2. The method for manufacturing a decorated molding according to claim 1, wherein the heat-shrinkable resin sheet has a pattern formed with an infrared absorption ink or an infrared reflection ink and includes the area A having the pattern formed with the infrared absorption ink or the infrared reflection ink and the area B having no pattern.

3. The method for manufacturing a decorated molding according to claim 1, wherein the heat-shrinkable resin sheet has a pattern formed with an infrared absorption ink or an infrared reflection ink and includes the area A having a high ink concentration and the area B having a low ink concentration.

4. The method for manufacturing a decorated molding according to claim 1, wherein the heat-shrinkable resin sheet has a pattern formed with multiple types of infrared absorption inks having different infrared absorptances or multiple types of infrared reflection inks having different infrared reflectances and includes the area A having a pattern formed with an ink having a high infrared absorptance or reflectance and the area B having a pattern formed with an ink having a low infrared absorptance or reflectance.

5. The method for manufacturing a decorated molding according to claim 1, wherein the heat-shrinkable resin sheet is composed of biaxially stretched polyethylene terephthalate.

6. (canceled)

7. (canceled)

8. The method for manufacturing a decorated molding according to claim 2, wherein the heat-shrinkable resin sheet is composed of biaxially stretched polyethylene terephthalate.

9. The method for manufacturing a decorated molding according to claim 3, wherein the heat-shrinkable resin sheet is composed of biaxially stretched polyethylene terephthalate.

10. The method for manufacturing a decorated molding according to claim 4, wherein the heat-shrinkable resin sheet is composed of biaxially stretched polyethylene terephthalate.
